(19) United States
(12) Patent Application Publication
(10) Pub. No.: US 2017/0115656 A1
(43) Pub. Date: Apr. 27, 2017

(54) Image-Based Placing of Workpiece Machining Operations

(71) Applicant: TRUMPF Werkzeugmaschinen GmbH + Co. KG, Ditzingen (DE)

(72) Inventors: Jens Ottnad, Karlsruhe (DE); Manuel Kiefer, Stuttgart (DE)

(21) Appl. No.: 15/401,298

(22) Filed: Jan. 9, 2017

Related U.S. Application Data
(63) Continuation of application No. PCT/EP2015/063565, filed on Jun. 17, 2015.

(30) Foreign Application Priority Data
Jul. 11, 2014 (DE) 102014213518.4

(51) Int. Cl. G05B 19/4097; B23K 26/03; B23K 37/04; B23K 26/38; B23K 37/02; G05B 19/401; B23K 26/08

(52) U.S. Cl. CPC G05B 19/4097; G05B 19/401; B23K 26/032; B23K 26/0876; B23K 26/38; B23K 37/0235; B23K 37/0408; G05B 2219/35075; G05B 2219/35162; G05B 2219/35506; G05B 2219/45041; G05B 2219/45234; B23K 2201/18

(57) ABSTRACT

Techniques are described for machining flat workpieces, such as metal sheets, or three-dimensional workpieces on a processing machine, such as a machine tool or laser cutting machine, including capturing a live image of a workpiece to be machined with an image capturing device for capturing two-dimensional images; displaying at least one workpiece machining operation to be performed in the live image of the workpiece by a predetermined forward transformation of the workpiece machining operation from the three-dimensional machine coordinate system into the two-dimensional live-image coordinate system; repositioning the workpiece machining operation to be performed in the live image of the workpiece; and performing the workpiece machining operation on the workpiece by a predetermined inverse transformation of the repositioned workpiece machining operation from the two-dimensional live-image coordinate system into the three-dimensional machine coordinate system.

### CROSS-REFERENCE TO RELATED APPLICATIONS

This application is a continuation of and claims priority under 35 U.S.C. §120 to PCT Application No. PCT/EP2015/063565 filed on Jun. 17, 2015, which claims priority to German Application No. 10 2014 213 518.4, filed on Jul. 11, 2014. The entire contents of these priority applications are incorporated herein by reference.

### TECHNICAL FIELD

The invention relates to a method for machining flat workpieces, in particular metal sheets, or three-dimensional workpieces on a processing machine, in particular a machine tool or laser cutting machine, to a processing machine suitable for carrying out the method and to an associated computer program product.

### BACKGROUND

The manual placing or subsequent positioning (repositioning) of workpiece machining operations to be performed is in many cases time-consuming, inaccurate and susceptible to errors. First, the component dimension must be determined, then the raw material is manually measured, and finally the starting point must be established, for example with the aid of the laser diode. Since these items of information are often insufficient, a dry run is often initially carried out in order to avoid error-affected production or damage to the processing machine.

It is known from JP 11-320143 to use a camera for two-dimensionally scanning a metal sheet that is to be machined and to display it on a screen together with workpiece parts to be cut and also to cover a free region of the metal sheet automatically with further workpiece parts that are to be cut. This method presupposes however that the free region of the metal sheet is correctly detected by image processing, because otherwise some regions of the metal sheet, for example soiled regions, are detected by the image processing as already machined and are therefore no longer made available for the nesting of further parts.

### SUMMARY

The present disclosure provides methods for machining workpieces and associated processing machines and computer program products to simplify the manual placing and/or repositioning of a workpiece machining operation.

These objects are achieved according to embodiments described herein by methods for machining flat workpieces, e.g., metal sheets, or three-dimensional workpieces on a processing machine, e.g., a machine tool or laser cutting machine, with the following method steps:
a) capturing a live image of a workpiece to be machined with an image capturing device for capturing two-dimensional images;
b) displaying at least one workpiece machining operation to be performed in the live image of the workpiece by a predetermined forward transformation of the workpiece machining operation from the three-dimensional machine coordinate system into the two-dimensional live-image coordinate system;
c) manually repositioning the workpiece machining operation to be performed in the live image of the workpiece; and
d) performing the workpiece machining operation on the workpiece by a predetermined inverse transformation of the repositioned workpiece machining operation from the two-dimensional live-image coordinate system into the three-dimensional machine coordinate system.

According to at least some embodiments, a planned workpiece machining operation to be performed (for example a laser cut to be carried out) is superposed on the live image of the workpiece as a result preview, that is to say it is indicated exactly where the workpiece machining operation, for example a cutting contour, would be executed. It is therefore immediately evident to the operator whether error-free production with good material utilization is possible. If required, the operator can manually reposition the contour to be executed in the live image or nest it with other contours. Then the repositioned workpiece machining operation is transformed back into the machine coordinate system and correspondingly executed. On the one hand for displaying in the live image the workpiece machining operation planned in the machine coordinate system and on the other hand for performing in the machine coordinate system the workpiece machining operation repositioned in the live-image coordinate system, the forward and inverse transformations between the machine coordinate system and the live-image coordinate system is known. For this, the two-dimensional live image of the image capturing device (for example a camera with two-dimensional or three-dimensional perspective viewing the workpiece to be machined) is calibrated in relation to the three-dimensional machine coordinate system. Such a calibration may, but does not have to be, carried out in advance for each new workpiece.

The methods according to at least some embodiments also offer the following further advantages:
Intuitive operation: The viewing angle in the live image corresponds to the accustomed view into the machine. All transformations, re-calculations and repositionings are then automatically resolved in the background and graphically presented.
Simplified and intuitive operation as a result of direct allocation of the machining operation to be performed in the live image (WYSIWYG: “What you see is what you get”) leads to a saving of time in comparison with the manual machining of workpiece surfaces.
Preview of the machining result as a superposed representation in the live image and easy optimization, for example by displacement/turning/reflection of a workpiece part, directly at the machining level.
Avoidance of errors as a result of result preview and greatly simplified operation.
Material efficiency, since the workpiece surface can be used without safety reserves.
Robust solution, because placement is independent of unfavorable exposure conditions, reflective surfaces or other influences when recording the image that for example make solutions with image processing more difficult.
Optimized machining, because it is possible to perform a desired alignment of the machining to be placed, for example according to the direction of the fibers (CFR materials) or surface textures (films, textile fabric), because these items of information are in the live image.

In some embodiments, before method step a), the image capturing device is used to capture a reference live image having at least three machine reference points the three-dimensional position of which is in each case known in the machine coordinate system, and that then the forward and inverse transformations between the three-dimensional machine coordinate system and the two-dimensional live-image coordinate system are determined on the basis of the machine reference points and their associated reference image points in the reference live image. By calibration of at least three live image coordinates (reference image points) in relation to known machine reference points, a machining contour (for example a laser cut to be carried out) can be presented in a superposing manner in the live image exactly where the contour would be executed. As a result, reference points in the machine working space are uniquely assigned reference image points in the live image, and in this way the camera is calibrated.

In some embodiments, at least a fourth machine reference point, the three-dimensional position of which is known in the machine coordinate system, is captured or a distortion factor, in particular for the correction of optical distortions of the image capturing device, is determined. The forward and inverse transformations between the three-dimensional machine coordinate system and the two-dimensional live-image coordinate system can be determined on the basis of the at least four machine reference points or on the basis of the at least three machine reference points and the distortion factor, and also on the basis of the associated reference image points in the reference live image. The distortion factor may, for example, be determined indirectly by recording a predetermined pattern with the camera and image analysis or be measured directly by way of a Shack-Hartmann arrangement and described by superpositioning of Zernike polynomials. As a result, the forward and inverse transformations between the machine coordinate system and the live-image coordinate system are determined much more precisely, so that less of a safety margin, for example from workpiece edges or other workpiece machinings, need be maintained in the manual repositioning of the workpiece machining operation to be performed in the live image.

In one variant, at least some, in particular all, of the reference image points corresponding to the machine reference points in the reference live image are manually assigned by the operator, for example in that the operator selects the reference image points in the reference live image on the user interface by clicking on them. In another variant, at least some, e.g., all, of the reference image points corresponding to the machine reference points in the reference live image are assigned by an automatic image recognition of notable machine reference points. Advantageously, one of the machine reference points may be formed by a movable machine component (for example by the laser machining head of a laser processing machine) that has been moved to a position known in the machine coordinate system before the capture of the at least one reference live image. Alternatively, machine reference points may be added by machining operations in a workpiece, for example by markings or cutting out circles of holes. It is also possible to use the contours of cut workpiece parts of a previous machining as machine reference points. In addition, one or more machine reference points may be produced by projection of a point or a geometry onto the one or more locations of the reference level, for example with one or more (movable) laser diodes. As a result, the surface of the workpiece (that is facing the image capturing device) forms the reference level.

In some embodiments, in method step c), the manual repositioning comprises at least one of the following operations: turning a workpiece part to be cut, displacing a workpiece part to be cut, aligning (nesting) workpiece parts to be cut, turning and/or displacing and/or adjusting in height a raising or pushing-out element (for example a sucker, a magnetic, electroadhesive or pincer gripper, or an ejector pin), positioning a separating cut or teaching points for other manual machining or setting-up operations.

In some embodiments, before method step b), the workpiece thickness is captured, in order in method step b) to display the planned workpiece machining operation in the live image of the workpiece not at the supporting level (underside) of the workpiece, but on the upper side facing the image capturing device (machining level) of the workpiece. This allows workpiece machining operations to be placed in the live image at the actual machining level instead of at the supporting level, which is relevant in particular in the case of thick metal sheets.

In some embodiments, to present a workpiece machining operation in the live image such that it is correctly displayed (and later performed) on the surface of a three-dimensional workpiece, the forward transformation known for a flat workpiece, which displays workpiece machining at the supporting level/workpiece level of a flat workpiece, is adapted to the three-dimensional workpiece surface. For this purpose, the forward and inverse transformations for workpiece machining operations on a three-dimensional workpiece are determined as follows from the forward and inverse transformations known for workpiece machining operations on flat workpieces:

(i) displaying a computer-aided design (CAD) representation, in particular at least a part-CAD representation of the workpiece, in the live image of the workpiece by the forward transformation of the CAD representation that is known for flat workpieces from the three-dimensional CAD coordinate system into the two-dimensional live-image coordinate system, the CAD representation that is displayed in the live image being differently scaled according to its position in the live image; and

ii) adapting the forward and inverse transformations known for flat workpieces to the three-dimensional workpiece by displacing the position-dependent CAD representation of the workpiece in the live image of the workpiece until in the live image the CAD representation at least partially, in particular completely, congruently superposes the workpiece.

A CAD representation comprises at least a single line that is superposed at at least one defined point by a known point of the reference level and at least one further defined point of the workpiece.

Alternatively, a part-CAD representation of the workpiece at the supporting level is displayed in the live image and is then displaced manually by an operator (or in an automated manner by another image recognition) in the live image until it is congruent with the actual workpiece in the live image. The part-CAD representation may be for example the underside of the workpiece, or else the complete CAD representation of the workpiece is displayed in the live image of the workpiece. As a result, it is easily possible to determine the positioning of the workpiece in the machine coordinate system.

In a further aspect, at least one embodiment also relates to a processing machine, in particular a machine tool or laser cutting machine, for machining flat workpieces, in particular metal sheets, with at least one image capturing device of a known location for the two-dimensional capture of an image of a workpiece to be machined, with a transformation unit for the forward and inverse transforming between the three-dimensional machine coordinate system and a two-dimensional live-image coordinate system, with a display for displaying a live image of the workpiece to be machined and a workpiece machining operation to be performed, with an operator control unit for the manual repositioning of the workpiece machining operation to be performed and with a machine control, which is programmed to control the workpiece machining operation according to the method described herein.

Finally, this disclosure also relates to computer program products, which have coding means that are adapted for carrying out all of the steps of the machining methods described herein when the programs run on a machine control of a processing machine.

Further advantages and advantageous refinements of the subject matter of the disclosure can be taken from the description, the drawings, and the claims. Similarly, the features mentioned above and features still to be set out can each be used on their own or together in any desired combinations. The embodiments shown and described should not be understood as an exhaustive list, but rather as being of an exemplary character for the description of the invention.

### DESCRIPTION OF DRAWINGS

FIG. 1 shows a laser cutting machine suitable for carrying out the machining operation according to the embodiments disclosed herein with the image-based placing of workpiece machining operations in a live image of the workpiece.

FIG. 2 shows the laser cutting machine of FIG. 1 when calibrating a live-image coordinate system.

FIG. 3 shows the pushing out of a canted workpiece part by an ejector pin of the laser cutting machine.

FIGS. 4A, 4B, 4C, 4D and-4E show a live image of a three-dimensional workpiece with a superposed CAD representation of the three-dimensional workpiece, the CAD representation being superposed at various positions of the live image.

### DETAILED DESCRIPTION

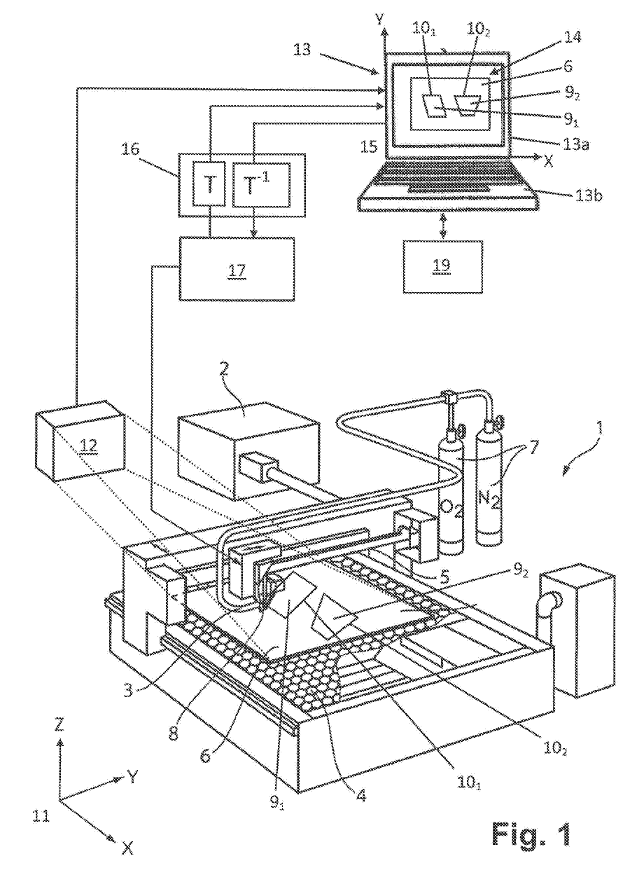

The laser cutting machine 1, represented perspectively in FIG. 1 as a flat-bed machine, comprises a laser beam generator 2, which is configured for example as a CO₂ laser, diode laser, or solid-state laser, a laser machining head 3, which is movable in the X direction and the Y direction, and a workpiece support 4. The laser beam generator 2 generates a laser beam 5, which is guided by means of an optical-fiber cable (not shown) or a deflecting mirror (not shown) from the laser beam generator 2 to the laser machining head 3. The laser beam 5 is directed by means of a focusing optic, which is arranged in the laser machining head 3, onto a workpiece (for example a metal sheet) 6, which rests on the workpiece support 4.

The laser cutting machine 1 is additionally supplied with process gases 7, for example oxygen and nitrogen. The process gas 7 is fed to a process gas nozzle 8 of the laser machining head 3, from which it leaves together with the laser beam 5.

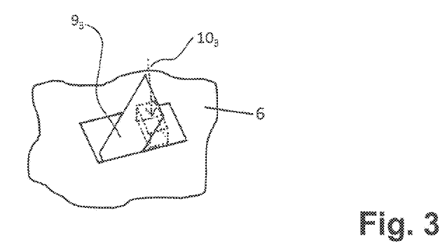

The laser cutting machine 1 serves for the laser cutting of workpiece parts 9₁, 9₂ from the workpiece 6, the workpiece machining operations (cutting contours) that are required for this being represented by 10₁, 10₂. The three-dimensional machine coordinate system XYZ is denoted overall by 11. The laser machining head, or part thereof, may act as an ejector pin, which pushes down a workpiece part 9₃ that has been cut but has not fallen because of canting, at a suitable location to discharge it, as shown in FIG. 3. The associated workpiece machining operation, that is to say the pushing out of the workpiece 9₃ by the ejector pin, is denoted by 10₃.

The laser cutting machine 1 also comprises an image capturing device 12, of a known location on the machine side and fixedly arranged here, in the form of a camera, for the two-dimensional capture of an image of the workpiece support 4 or of the workpiece 6 resting on it. The viewing range of the image capturing device 12 is represented by dotted lines. The captured image is displayed on a display 13a of an operator interface 13 of the machine 1 as a live image 14 of the workpiece 6. The two-dimensional live-image coordinate system XY of the display 13a is denoted overall by 15. The laser cutting machine 1 also comprises a transformation unit 16 for the forward and inverse transforming T, T⁻¹ between the three-dimensional machine coordinate system 11 and the two-dimensional live-image coordinate system 15, and also a machine control 17.

In the following, the new methods disclosed herein are described for the image-based repositioning (placing) of a workpiece machining operation 10₁, 10₂, 10₃ to be performed.

First, an image of the workpiece 6 to be machined is recorded by the image capturing device 12 (from a 2D or 3D perspective) and displayed in the display 13a as a two-dimensional live image 14 of the workpiece 6. A workpiece machining operation 10₁, 10₂, 10₃ to be performed, which is in the three-dimensional machine coordinate system 11 for example as an executable machine program (computer numerical control

(CNC) program), is transformed in the transformation unit 16 by a predetermined forward transformation T from the three-dimensional machine coordinate system 11 into the two-dimensional live-image coordinate system 15 and likewise displayed in the display 13a—superposed on the live image 14 of the workpiece 6. The desired workpiece machining operation 10₁, 10₂ is therefore superposed as a result preview in the live image 14 of the workpiece 6, so that it is immediately evident whether error-free production with good material utilization is possible.

If required, the displayed workpiece machining operation 10₁, 10₂, 10₃ can then be repositioned directly in the live image 14 of the workpiece 6 by the operator by means of an input device (keyboard, mouse) 13b of the operator interface 13. The manual repositioning may be, for example, the turning or displacing of a workpiece part 9₁, 9₂ to be cut, or its cutting contour, the aligning (nesting) of a number of workpiece parts 9₁, 9₂ to be cut, or the turning and/or displacing and/or adjusting in height of a raising or pushing-out element (for example a sucker, a magnetic, electroadhesive or pincer gripper, or an ejector pin), or the positioning of a separating cut or of teaching points for other manual machining or setting-up operations.

Finally, the workpiece machining operation 10₁, 10₂, 10₃ repositioned in the live image 14 is transformed in the transformation unit 16 by a predetermined inverse transformation T⁻¹ from the two-dimensional live-image coordinate system 15 back into the three-dimensional machine coordinate system 11 and, after creating an associated NC program, then performed on the workpiece 6. The machine control 17 is programmed to control the workpiece machining according to this method.

Before the superposed display of the workpiece 6 and the workpiece machining operation 10₁, 10₂, 10₃ in the display 13a, the workpiece thickness may be captured by measurement or manual input, to display the planned workpiece machining operation 10₁, 10₂, 10₃ in the live image 14 of the workpiece 6 not at the supporting level (underside) of the workpiece 6, but on the upper side facing the image capturing device 12 (machining level) of the workpiece 6. This allows workpiece machining operations 10₁, 10₂, 10₃ to be placed in the live image 14 at the actual machining level instead of at the supporting level, which is relevant in particular in the case of thick metal sheets. Alternatively, the machine reference points P1-P4 may be arranged directly on the surface of the workpiece 6, for example by adding machine reference points P1-P4 by machining operations in a workpiece 6, for example by markings or cutting out circles of holes. It is also possible to use the contours of previously cut workpiece parts of a previous machining as machine reference points P1-P4. In addition, one or more machine reference points may be produced by projection of a point or a geometry onto one or more locations of the surface of the workpiece 6, for example with one or more (movable) laser diodes. As a result, the surface of the workpiece 6 (that is facing the image capturing device 12) forms the reference level.

In at least some embodiments, a precondition for the described method for the image-based repositioning of workpiece machining operations 10₁, 10₂, 10₃ is the determination of the forward and inverse transformation T, T⁻¹ for the calibration of the image capturing device 12 with view to the workpiece 6, in order to assign spatial points in the machine coordinate system 11 (machine working space) unique image points in the live-image coordinate system 15 or in the live image 14.

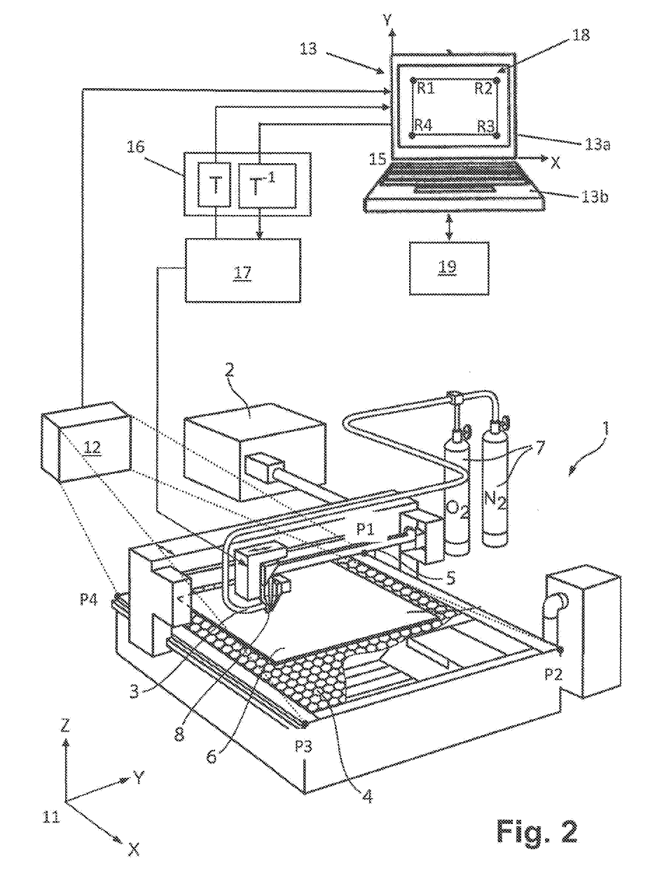

FIG. 2 shows, by way of example, how the image capturing device 12 can be calibrated in advance. First, the image capturing device 12 is used to capture a reference image having at least three (here four) machine reference points P1-P4 the three-dimensional position of which is in each case known in the machine coordinate system 11, and it is displayed as a reference live image 18 in the display 13a. On the basis of the machine reference points P1-P4 and their associated reference image points R1-R4 in the reference live image 18, the forward and inverse transformations T, T⁻¹ between the three-dimensional machine coordinate system 11 and the two-dimensional live-image coordinate system 15 can be determined. The reference image points R1-R4 corresponding to the machine reference points P1-P4 in the reference live image 18 may for example be assigned by the operator manually or by an automated image recognition 19. The movable laser machining head 3 may also form one of the machine reference points P1-P4, if it has been moved to a position known in the machine coordinate system 11 before the capture of the reference live image 18.

Instead of the one image capturing device 12 that is shown, a number of image capturing devices 12 with overlapping or respectively adjacent viewing ranges may also be used. It is also possible however for one or more movable image capturing devices 12 to be provided, for example by arrangement of the image capturing devices 12 on a machining element, such as for example the laser head 3, or by an axis of motion that can be moved separately therefrom.

The forward transformation T obtained from three to four machine reference points is sufficient to project a two-dimensional and three-dimensional representations on the basis of a desired reference level (supporting level) into the two-dimensional live image 14. However, depending on at which position this representation is displayed in the live image 14, the representation projected in the live image 14 is differently scaled. In order to display the projected representation at the correct position in the live image 14, the forward transformation T must therefore be correspondingly scaled in advance. To determine the associated scaling factor, a CAD representation of the three-dimensional workpiece at the supporting level may be displayed in the live image 14, and the operator (or another image recognition) then displaces the CAD representation until it is congruent with the displayed image of the workpiece in the live image 14.

More generally, a CAD representation may comprise at least a single line that is superposed at at least one defined point by a known point of the reference level and at least one further defined point of the workpiece. Thus, it is for example possible for the operator to superpose in the live image a corner of an upright edge of a tilted workplace 6 with a defined point of a line running perpendicularly in the machine coordinate system and to superpose a point at the reference level that is located perpendicularly below the corner with the further defined point. Because of the known scaling factors and orientation of the line, the length of the line between the two defined points establishes a distance, whereby in this case the height of the upright corner can be determined. This height may be used for example to push out the tilted workpiece 6 from a remaining lattice with an implement or ensure that there are no risks of collision with the tool (for example the laser head). This function consequently represents a kind of gage by which dimensions can be determined in the live image to carry out workpiece machining operations more accurately or more reliably.

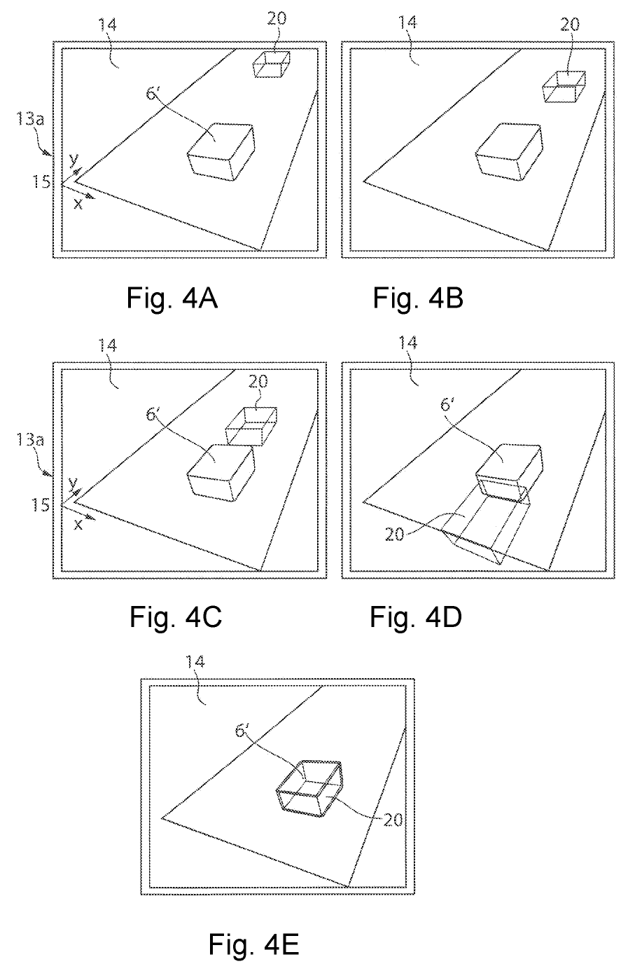

FIGS. 4A, 4B, 4C, 4D to 4E, show, by way of example, how the scaled forward and inverse transformations T′, T′⁻¹ for workpiece machining operations on a three-dimensional workpiece 6′ can be determined from the forward and inverse transformations T, T⁻¹ known for workpiece machining operations on flat workpieces 6.

The image of the three-dimensional workpiece 6′ that is recorded with the image capturing device 12, here by way of example a cuboid, is displayed as a live image 14 on the display 13a of the user interface 13. In this live image 14 of the workpiece 6′, a CAD representation 20 of the three-dimensional workpiece 6′ is displayed by the forward transformation T of the CAD representation 20 that is known for flat workpieces 6 from the three-dimensional CAD coordinate system into the two-dimensional live-image coordinate system 15. Depending on at which position the CAD representation 20 is displayed in the live image 14, the CAD representation 20 displayed in the live image 14 is differently scaled. The displayed CAD representation 20 of the workpiece 6′ is displaced manually by the operator or in an automated manner in the live image 14 of the workpiece 6 (FIGS. 4A-4E) and the underlying forward transformation is thereby changed. With the respective displacing position, the size of the displayed CAD representation 20 also changes. When in the live image 14 the displayed CAD representation 20 congruently superposes the displayed image of the workpiece 6′

(FIG. 4e), the sought forward transformations T′ for the three-dimensional workpiece 6′ has been found. This can then also be used to determine the inverse transformation for the three-dimensional workpiece 6′.

The manual or automated displacing of the CAD representation 20 of the three-dimensional workpiece 6′ in the live image 14 of the workpiece 6′ may be performed for example by way of the operator control unit 13b.

Instead of displaying the three-dimensional workpiece 6′ in the live image 14 as a complete CAD representation 20, as in at least some of the examples of FIGS. 4A-4B, it is also possible for only part, for example the underside, of the workpiece 6′ to be displayed as a part-CAD representation 20 in the live image 14 and to be displaced until in the live image 14 the displaced CAD representation 20 congruently superposes the underside of the displayed workpiece 6′.

With the aid of the forward transformation T′ thus determined, it is possible to transform a workpiece machining operation 10₁, 10₂, 10₃ to be performed, which is in the three-dimensional machine coordinate system 11 for example as an executable machine program (NC program), in the transformation unit 16 by the forward transformation T′ from the three-dimensional machine coordinate system 11 into the two-dimensional live-image coordinate system 15 and likewise display it in the display 13a—superposing the live image 14 of the workpiece 6′. The desired workpiece machining operation 10₁, 10₂ is therefore superposed as a result preview in the live image 14 of the workpiece 6′, so that it is immediately evident whether error-free production with good material utilization is possible. Thus, the same method steps that are stated in the description in relation to substantially flat workpieces 6 can be carried out.

### Other Embodiments

A number of embodiments have been described. Nevertheless, it will be understood that various modifications may be made without departing from the spirit and scope of the invention. Accordingly, other embodiments are within the scope of the following claims.

What is claimed is:

1. A method for machining workpieces by a processing machine, the method comprising:
capturing a live image of a workpiece to be machined with an image capturing device for capturing two-dimensional images, wherein the live image of the workpiece to be machined is captured with the image capturing device from a three-dimensional perspective and displayed from the three-dimensional perspective;
displaying at least one workpiece machining operation to be performed as a result preview in the live image of the workpiece, wherein the at least one workpiece machining operation to be performed is displayed by a predetermined forward transformation of the at least one workpiece machining operation from a three-dimensional machine coordinate system into a two-dimensional live-image coordinate system;
repositioning the at least one workpiece machining operation to be performed in the live image of the workpiece; and
performing the at least one workpiece machining operation on the workpiece, wherein the at least one workpiece machining operation is performed by a predetermined inverse transformation of the at least one repositioned workpiece machining operation from the two-dimensional live-image coordinate system into the three-dimensional machine coordinate system.

2. The method of claim 1, wherein, before the capturing of the live image, the image capturing device is used to capture a reference live image having at least three machine reference points, wherein the three-dimensional position of each machine reference point is described in the three-dimensional machine coordinate system, and wherein the forward and inverse transformations between the three-dimensional machine coordinate system and the two-dimensional live-image coordinate system are determined on the basis of the at least three machine reference points and their associated reference image points in the reference live image.

3. The method of claim 2, wherein at least a fourth machine reference point, the three-dimensional position of which is described in the three-dimensional machine coordinate system, is captured or a distortion factor for the correction of optical distortions of the image capturing device is determined, and wherein the forward and inverse transformations between the three-dimensional machine coordinate system and the two-dimensional live-image coordinate system are determined on the basis of the at least four machine reference points or on the basis of the at least three machine reference points and the distortion factor, and also on the basis of the associated reference image points in the reference live image.

4. The method of claim 2, wherein at least one of the reference image points corresponding to the machine reference points in the reference live image is assigned manually by an operator.

5. The method of claim 3, wherein at least one of the reference image points corresponding to the machine reference points in the reference live image is assigned manually by an operator.

6. The method of claim 2, wherein at least one of the reference image points corresponding to the machine reference points in the reference live image is assigned by an automatic image recognition.

7. The method of claim 3, wherein at least one of the reference image points corresponding to the machine reference points in the reference live image is assigned by an automatic image recognition.

8. The method of claim 2, wherein at least one of the machine reference points is formed by a movable machine component that is moved to a position described in the three-dimensional machine coordinate system before the capture of the reference live image.

9. The method of claim 8, wherein the movable machine component is a laser machining head.

10. The method of claim 1, wherein the forward and inverse transformations for the at least one workpiece machining operation on a three-dimensional workpiece are determined as follows from the forward and inverse transformations for workpiece machining operations on flat workpieces:
displaying at least a part-CAD representation of the three-dimensional workpiece in the live image of the workpiece by the forward transformation of a CAD representation for the flat workpieces from a three-dimensional CAD coordinate system into the two-dimensional live-image coordinate system, the CAD representation that is displayed in the live image being differently scaled according to its position in the live image; and
adapting the forward and inverse transformations for the flat workpieces to the three-dimensional workpiece by displacing the position-dependent CAD representation of the three-dimensional workpiece in the live image of the workpiece until, in the live image, the CAD representation at least partially congruently superposes the workpiece.

11. The method of claim 10, wherein the part-CAD representation comprises at least the underside of the workpiece.

12. The method of claim 10, wherein a complete CAD representation of the workpiece is displayed in the live image of the workpiece.

13. The method of claim 10, wherein the position-dependent CAD representation of the workpiece is displaced manually in the live image of the workpiece.

14. A processing machine for machining workpieces, the processing machine comprising:
at least one image capturing device arranged to perform a two-dimensional capture, from a three-dimensional perspective, of an image of a workpiece to be machined;
a transformation unit arranged to perform forward and inverse transforming between a three-dimensional machine coordinate system and a two-dimensional live-image coordinate system;
a monitor arranged to display a live image of the workpiece to be machined and to display a result preview from the three-dimensional perspective of a workpiece machining operation to be performed;
an operator control unit arranged to reposition the workpiece machining operation to be performed in the live image; and
a machine control programmed to control workpiece machining, including performing the workpiece machining operation on the workpiece, wherein the workpiece machining operation is performed by a predetermined inverse transformation of the repositioned workpiece machining operation from the two-dimensional live-image coordinate system into the three-dimensional machine coordinate system.

15. The processing machine of claim 14, wherein the operator control unit is further arranged to displace a CAD representation of a three-dimensional workpiece in the live image of the workpiece.

16. One or more computer-readable storage media storing instructions which, when executed by at least one computer, instruct the at least one computer to perform operations comprising:
receiving a live image of a workpiece to be machined, the live image captured with an image capturing device for capturing two-dimensional images, wherein the live image of the workpiece to be machined is captured with the image capturing device from a three-dimensional perspective and displayed from the three-dimensional perspective;
displaying at least one workpiece machining operation to be performed as a result preview in the live image of the workpiece, wherein the at least one workpiece machining operation to be performed is displayed by a predetermined forward transformation of the at least one workpiece machining operation from a three-dimensional machine coordinate system into a two-dimensional live-image coordinate system;
repositioning the at least one workpiece machining operation to be performed in the live image of the workpiece; and
performing the at least one workpiece machining operation on the workpiece, wherein the at least one workpiece machining operation is performed by a predetermined inverse transformation of the at least one repositioned workpiece machining operation from the two-dimensional live-image coordinate system into the three-dimensional machine coordinate system.

17. The one or more computer-readable storage media of claim 16, the operations further comprising:
receiving a reference live image captured by the image capturing device, the reference live image having at least three machine reference points, wherein the three-dimensional position of each machine reference point is described in the three-dimensional machine coordinate system, and wherein the forward and inverse transformations between the three-dimensional machine coordinate system and the two-dimensional live-image coordinate system are determined on the basis of the at least three machine reference points and their associated reference image points in the reference live image.

18. The one or more computer-readable storage media of claim 17, wherein at least a fourth machine reference point, the three-dimensional position of which is described in the three-dimensional machine coordinate system, is captured or a distortion factor for the correction of optical distortions of the image capturing device is determined, and wherein the forward and inverse transformations between the three-dimensional machine coordinate system and the two-dimensional live-image coordinate system are determined on the basis of the at least four machine reference points or on the basis of the at least three machine reference points and the distortion factor, and also on the basis of the associated reference image points in the reference live image.

19. The one or more computer-readable storage media of claim 18, wherein at least one of the reference image points corresponding to the machine reference points in the reference live image is assigned manually by an operator.

20. The one or more computer-readable storage media of claim 18, wherein at least one of the reference image points corresponding to the machine reference points in the reference live image is assigned by an automatic image recognition.
